(19) United States
(12) Patent Application Publication
(10) Pub. No.: US 2007/0097956 A1
(43) Pub. Date: May 3, 2007

(54) Device service activation for voice over internet protocol service

(76) Inventors: Anton Okmianski, Lincoln, MA (US); Allen J. Huotari, Garden Grove, CA (US); Mickael Graham, Lincoln, MA (US)

Correspondence Address: MACPHERSON KWOK CHEN & HEID LLP, 2033 GATEWAY PLACE, SUITE 400, SAN JOSE, CA, 95110, US

(21) Appl. No.: 11/263,329

(22) Filed: Oct. 31, 2005

(51) Int. Cl. H04L 12/66

(52) U.S. Cl. 370/352; 370/401

(57) ABSTRACT

Systems and techniques herein may allow users to subscribe to Internet services such as VoIP without access to a personal computer. An Internet service device may include an input to receive information indicative of a selected service provider. The Internet service device may be configured to automatically discover a location of a configuration service for the selected service provider, and to transmit a device identifier to the selected service provider. In some embodiments, the configuration service may be discovered using a DNS SRV process.

### BACKGROUND

Emerging consumer services such as VoIP (Voice over Internet Protocol) present a unique opportunity to service providers (SPs), as large markets open up in a relatively short time. Larger service providers may have a number of advantages when a new service is introduced to consumers, since they may bundle services with products. For example, Vonage (a VoIP service provider) sells its VoIP services bundled with a Linksys product that is pre-configured exclusively for Vonage. The service provider-specific device is sold to consumers through retail or other channels.

By contrast, smaller service providers generally are not able to bundle their services with Internet service devices in retail distribution. To subscribe to a service provided by a smaller service provider, a subscriber may need to purchase a non-bundled Internet service device, select a service provider, and then perform an installation process to configure the device to contact the service provider's configuration server. Herein, the phrase “Internet service device” refers to a device (or a portion of a device) configured to provide one or more services via an established Internet connection, rather than to provide and/or establish the Internet connection.

FIG. 1 shows an example of a process 100 a subscriber may perform to select a service provider after the purchase of a non-bundled Internet service device.

At 110, a subscriber may register with a selected service provider. For example, the subscriber may access a subscription server for the selected service provider via browser access of the Internet. At 120, the service provider associates the subscriber Internet service device with the subscriber identity. One common mechanism for associating the subscriber identity with the identity of the particular Internet service device is for the subscriber to provide the serial number of the device during registration.

At 130, the service provider configures the Internet service device to contact the service provider configuration server. One method that may be used is http redirection, where the subscriber's http request is redirected to the Internet service device's private IP address, with a URL (uniform resource locator) that includes the service provider configuration server location. The Internet service device and the configuration server may then communicate.

A process such as process 100 of FIG. 1 is generally more difficult and complicated than installing an Internet service device pre-configured for a particular service provider. Since ease of installation and use is an important factor for many consumers, larger service providers may enjoy an appreciable advantage in the marketplace.

A further difficulty with many installation processes is that they require a user device such as a personal computer to perform the installation process. For some services, such as VoIP, the provided service can be independent of a personal computer. Therefore, existing systems and techniques for providing VoIP services (and other Internet-provided services that are independent of a personal computing system) may not be suitable for all potential consumers.

### BRIEF DESCRIPTION OF THE DRAWINGS

FIG. 1 is a process that may be used to subscribe to a service provider, according to the prior art;

FIG. 2 is a process that may be used to subscribe to a service provider, according to some embodiments; and

FIG. 3 is a schematic of an Internet service device, according to some embodiments.

Like reference symbols in the various drawings indicate like elements.

### DETAILED DESCRIPTION

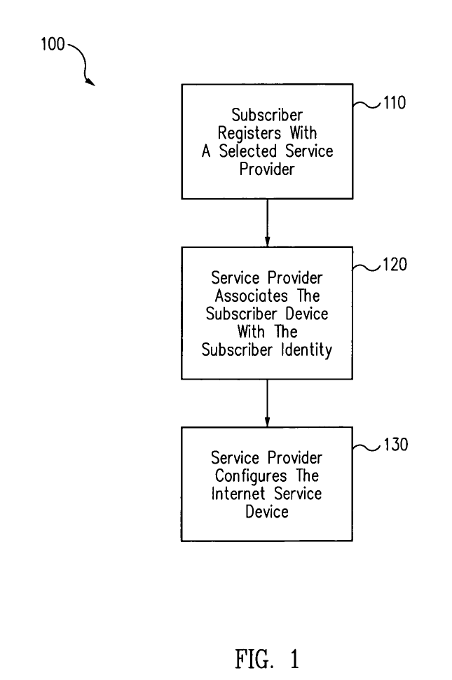

As noted above, an installation process such as process 100 of FIG. 1 may be unduly complicated for some subscribers, and may make Internet services unavailable to some interested consumers. Additionally, the process may have other unsatisfactory features. For example, since a subscriber may need to manually enter the serial number of the subscriber's Internet service device, the process is prone to human error.

As noted above, current systems may require a personal computer or other user device separate from the Internet service device to subscribe to the service provider. Although many people do use personal computers for Internet access, others may have the ability to access the Internet (at least some of the time) but may not have a personal computer. For example, some users may sign up for Internet access exclusively for the purpose of using VoIP phone services.

The current disclosure provides a cost-effective, easy to use system for using Internet services. The user selects a service provider for the Internet service device without using a personal computer. The Internet service device then automatically discovers a configuration service of the selected service provider using a discovery method (such as DNS-SRV). The Internet service device automatically provides identifier information to the configuration service, so that the user does not need to perform a manual process (such as entering a serial number of the device). Since no personal computer is required, and since the user can choose from a wide range of available service providers rather than a small number of service providers for pre-configured devices, the techniques are cost-effective. Further, automatic discovery and configuration make subscription and installation easy enough for non-technologically savvy users.

As an example, the users can select a service provider and subscribe to the service using a telephone, rather than a personal computer. Additionally, rather than being constrained to subscribe to a limited number of service providers whose services are bundled with pre-configured devices, users can select a service provider based on cost or other important characteristics. Finally, the current disclosure simplifies the installation process without being pre-configured for a particular service provider.

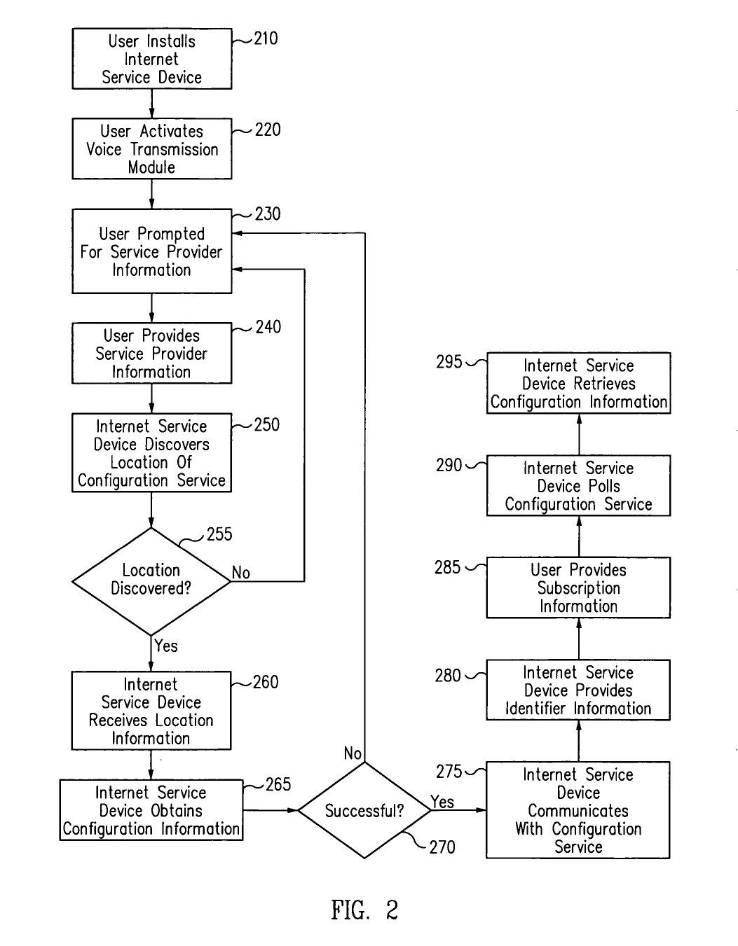

FIG. 2 shows a method 200 that may be used to subscribe to a selected service provider using a particular Internet service device, without a user device such as a personal computer.

At 210, a user installs an Internet service device such as a VoIP device. For example, the user may connect the Internet service device to the Internet via a wired or wireless connection (e.g., a WiFi or WiMax connection). The user may also connect the Internet service device to voice/tone transmission module such as a telephone. In some embodiments, the voice transmission module and the Internet service device may be integrated, while in other embodiments they may be at least partially separate. For example, for a VoIP system, a VoIP Internet service device may be integrated with a telephone.

At 220, the user activates the voice/tone transmission module; for example, the user may pick up the telephone handset. In response to the activation, a communication module comprising a voice/tone module such as an interactive voice response (IVR) module of the Internet service device may prompt the user to provide service provider information at 230. An IVR module may be implemented in hardware, software, or both.

An IVR module may include hardware and/or instructions to receive an analog signal indicative of a received voice signal (e.g., an analog signal from a microphone), to convert the analog signal to a digital signal, and to process the digital signal to determine information included in the received voice signal. An IVR module may further include hardware and/or instructions to generate data indicative of a voice message to be transmitted, to convert the digital signal to an analog signal, and to transmit a voice signal indicative of the analog signal to a user (e.g., transmitted using one or more speakers driven by the analog signal).

The voice/tone module of the Internet service device may include a dual tone multi-frequency (DTMF, or touch-tone) module in addition to or instead of an IVR module. A DTMF module may receive touch-tone signals and determine associated touch tone information (e.g., the DTMF module may determine that a received touch-tone signal corresponds to the number 2 and the letters A, B, and C). The DTMF module may also include hardware and/or instructions to convert a received DTMF signal to associated data, and to process the data.

At 240, the user may provide service provider information. For example, the user may say the name of the service provider, may say a domain name of the service provider, or the like. In some embodiments, the user may select a service listen to or view a list of candidate service providers, and select a service provider by pressing buttons (e.g., press “1” to select a provider from a spoken list, or press keys to spell the name or code of a selected service provider). The user may have IVR assistance at one or more points in the service provider selection process. In response, the Internet service device may prompt the user to confirm the service provider identity.

The user may obtain service provider information in a number of ways. The user may access a web site associate with the Internet service device vendor, listing one or more appropriate service providers. However, the user need not access the Internet to obtain service provider information. The user may select a service provider from a list that may be provided with the Internet service device (e.g., a written list included with installation instructions, or a spoken list generated by a voice module of the Internet service device), may telephone the Internet service device vendor and obtain information about appropriate service providers, or may obtain the information in another way. Herein, the word “spoken” is used to describe verbal, auditory communication that is generated by a person and/or or by a machine (using a voice generator system).

At 250, the Internet service device may discover a location of a configuration service for the selected service provider. For example, the Internet service device may perform a DNS SRV lookup for the configuration server of the service provider, based on service provider information provided by the user and/or the Internet service device.

At 255, if the server is not discovered, the user may be prompted for different service provider information at 230. If the server is discovered, the Internet service device receives location information such as the Internet address and port of the service provider configuration server at 260.

At 265, the Internet service device contacts the configuration server to get configuration information associated with the selected service provider. The configuration information may be default, generic configuration information that provides a basic voice service to connect the subscriber either directly to service provider staff, to an interactive voice resource at the service provider, or other. At 270, if the Internet service device cannot obtain configuration information, the user may be prompted for different service provider information at 230.

At 275, if the Internet service device obtains sufficient configuration information, the Internet service device communicates with the configuration server of the service provider. At 280, the Internet service device provides identifier information about the Internet service device to the configuration server, so that the service provider can automatically associate the particular Internet service device with the subscription information.

At 285, the user provides subscription information to the service provider using one or more voice services (e.g., by speaking to a sales representative and/or by interacting with an IVR system of the service provider). At 290, the Internet service device may poll the configuration server; for example, at intervals. At 295, once the subscription process is complete and the configuration server is updated to include subscription information associated with the user, the Internet service device obtains configuration information associated with the subscribed user (such as a telephone number for VoIP service) and subscribed services. The configuration information may be retrieved based on polling the configuration server (as described above and shown in the embodiment of FIG. 2), or using a different trigger.

One or more security mechanisms may be implemented as part of process 200 of FIG. 2. For example, the Internet service device may be authenticated using, for example, a unique client-side certificate or other mechanism.

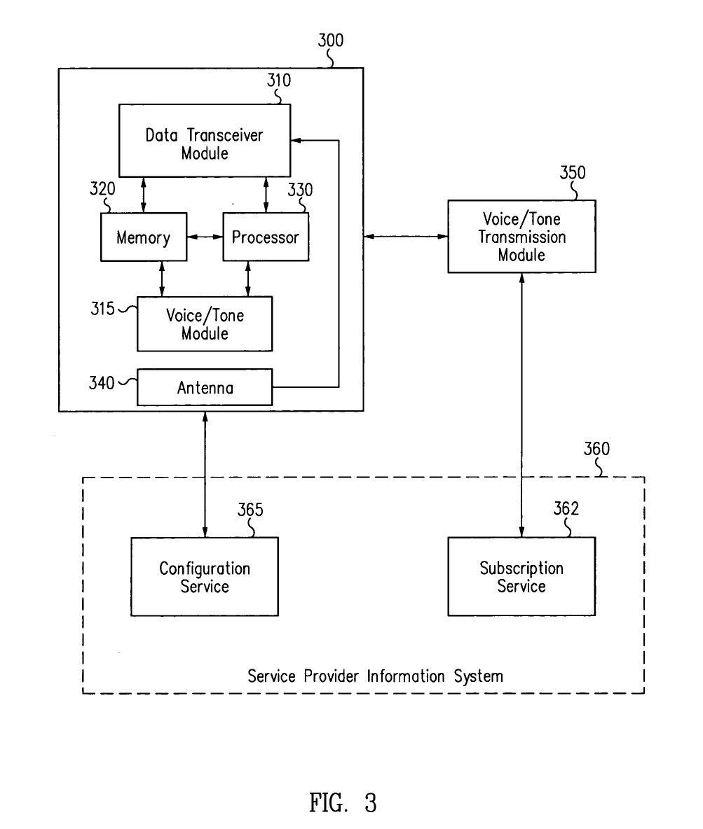

FIG. 3 shows an Internet service device 300 that may be used to provide Internet services to a user without the need for a personal computer or similar device.

Device 300 may be in communication with one or more systems such as a service provider information system 360 via a data transceiver module 310. Data transceiver module 310 may comprise one or more wired ports for input from and/or output to other systems, may comprise one or more wireless transceiver systems to receive and/or transmit data, or may comprise another type of system to receive and/or transmit data. For wireless interconnections (such as WiFi and WiMax interconnections), device 300 may include an antenna 340 in communication with data transceiver module 310.

Data and instructions to perform an installation process such as process 200 of FIG. 2 using device 300 may be included in a memory 320. Although shown as a single module, memory 320 may include more than one discrete memory module. Instructions may be executed using a processor 330, which may be implemented as a single processing unit, or may be implemented in multiple modules.

Device 300 may be in communication with one or more voice/tone transmission modules 350, such as a telephone at least partially integrated with device 300, or separate from device 300. Voice and/or tone information may be received on a communication module such as a voice/tone module 315 of device 300, which may be at least partially integrated with other modules of device 300 or may be a separate module. Voice/tone module 315 may include an input/output port for voice information (e.g., a telephone jack), and may include hardware and/or software for at least one of interactive voice response (IVR) processing and dual tone multi-function (DTMF) processing. At least some IVR/DTMF functionality may be implemented using memory 320 and/or processor 330 of device 300.

Device 300 may receive information indicating that voice/tone transmission module 350 has been activated. For example, a signal may be generated by voice/tone transmission module 350 when the handset is lifted, or when an “on” button is pushed.

In response, device 300 may execute instructions to generate a voice response prompting the user to select a service provider. The voice response may be transmitted to voice/tone transmission module 350 via module 315.

The user may respond with the name of a service provider, the domain name of a service provider, or in another manner. For example, system 300 may be configured to offer the user the option to select a service provider from a list generated using module 315. The user may confirm a service provider selection; for example, in response to a prompt generated in device 300 and transmitted via module 315.

In response to receiving service provider information, device 300 may execute instructions stored on memory 320 to perform one or more discovery processes to discover a location of one or more services of the selected service provider. For example, the instructions may include instructions to perform DNS SRV discovery of a configuration server 365 of the selected service provider information system 360.

Device 300 may execute stored instructions to transmit identifier information for device 300 to configuration server 365, so that the service provider can automatically associate device 300 with associated subscriber information. Device 300 may also execute instructions to contact the configuration service and obtain configuration information associated with the selected service provider, where the configuration information includes information to provide a basic voice service. Device 300 may use the configuration information to place the user in voice communication with the service provider; for example, by placing the user in voice communication with an IVR system at the service provider, or with service provider personnel. A subscription service 362 of the service provider information system 360 may receive subscription information (e.g., either directly from the IVR system or as entered by service provider personnel).

Device 300 may include instructions to poll configuration server 365 at intervals, or in response to one or more triggers. After the user has subscribed to the service provider, configuration server 365 may be updated with associated subscription information, and device 300 may receive configuration information such as a telephone number associated with the subscriber.

Once device 300 obtains sufficient configuration information, the user may use device 300 to obtain the Internet service. As noted above, one use of the systems and techniques herein is to obtain VoIP service. For VoIP service, once device 300 obtains configuration information, the user can use device 300 to place and receive calls.

In implementations, the above described techniques and their variations may be at least partially implemented as computer software instructions. Such instructions may be stored on one or more machine-readable storage media or devices and are executed by, e.g., one or more computer processors, or cause the machine, to perform the described functions and operations.

A number of implementations have been described. Although only a few implementations have been disclosed in detail above, other modifications are possible, and this disclosure is intended to cover all such modifications, and most particularly, any modification which might be predictable to a person having ordinary skill in the art. For example, Internet services devices other than VoIP devices may be used to provide service independent of a personal computer or other Internet-browsing device. Additionally, other types of voice and/or tone recognition may be used.

Also, only those claims which use the words “means for” are intended to be interpreted under 35 USC 112, sixth paragraph. Moreover, no limitations from the specification are intended to be read into any claims, unless those limitations are expressly included in the claims. Accordingly, other embodiments are within the scope of the following claims.

What is claimed is:

1. A device, comprising:
a data transceiver to transmit data from and receive data at the device;
a communication module, the communication module including an input to receive at least one of voice information and tone information at the device;
memory in communication with the data transceiver, the memory comprising a machine-readable medium embodying information indicative of instructions that when performed by one or more machines result in operations comprising:
receiving at least one of voice information and tone information indicative of a selected service provider on the input of the communication module; and
automatically discovering a location of a configuration service for the selected service provider.

2. The device of claim 1, wherein automatically discovering the location of the configuration service comprises automatically discovering the location of the configuration service using a DNS SRV process.

3. The device of claim 1, wherein the operations further comprise:
transmitting a device identifier to the selected provider.

4. The device of claim 1, wherein the operations further comprise:
receiving configuration information from the configuration service, the configuration information including instructions to enable voice communication with an information system of the selected service provider.

5. The device of claim 1, wherein the operations further comprise:
receiving subscriber configuration information from the configuration service, the subscriber configuration information associated with a subscriber.

6. The device of claim 1, wherein the device comprises a voice over Internet protocol device.

7. The device of claim 6, further comprising:
receiving subscriber configuration information from the configuration service, wherein the subscriber configuration information includes a telephone number associated with a subscriber.

8. The device of claim 1, further comprising one or more antennae in communication with the data transceiver.

9. The device of claim 1, wherein the device comprises a voice over Internet device at least partially integrated with a telephone.

10. The device of claim 1, wherein the device includes at least one of an interactive voice response module and a tone processing module.

11. An Internet service device comprising:
means for transmitting data from and receiving data at an Internet service device;
means for receiving at least one of voice signals and tone signals;
means for receiving at least one of voice information and tone information indicative of a selected service provider; and
means for automatically discovering a location of a configuration service for the selected service provider.

12. The device of claim 11, wherein the means for automatically discovering the location of the configuration service comprises means for automatically discovering the location of the configuration service using a DNS SRV process.

13. The device of claim 11, wherein further comprising means for transmitting a device identifier of the Internet service device to the selected provider.

14. The device of claim 15, further comprising means for receiving configuration information from the configuration service, the configuration information including instructions to enable voice communication with an information system of the selected service provider.

15. The device of claim 11, further comprising means for receiving subscriber configuration information from the configuration service, the subscriber configuration information associated with a subscriber.

16. The device of claim 15, wherein the device comprises a voice over Internet protocol device.

17. The device of claim 16, further comprising means for receiving subscriber configuration information from the configuration service, wherein the subscriber configuration information includes a telephone number associated with a subscriber.

18. The device of claim 16, wherein the device is at least partially integrated with a telephone.

19. A method comprising:
receiving at least one of a voice signal and a tone signal indicative of a selected service provider at an Internet service device, wherein the Internet service device is not configured to execute instructions for an Internet browser program;
discovering a location of at least one service of the selected service provider;
transmitting an identifier of the Internet service device using the location of the at least one service; and
receiving configuration information for the selected service provider.

20. The method of claim 19, wherein the configuration information comprises information to provide a voice service to access at least one system of the service provider.

21. The method of claim 20, wherein the at least one system of the service provider comprises an interactive voice response system of the service provider.

22. The method of claim 20, further comprising receiving subscriber configuration information from the service provider including subscription information for a subscriber associated with the subscriber configuration information.

23. The method of claim 22, wherein the Internet service device is a voice over Internet protocol device, and wherein the subscriber configuration information comprises a telephone number associated with the subscriber.
